(19) United States
(12) Patent Application Publication
(10) Pub. No.: US 2004/0067795 A1
(43) Pub. Date: Apr. 8, 2004

(54) Drive release mechanism

(76) Inventors: Anthony J. Cydzik, Garfield Heights, OH (US); Travis G. Ramler, Elyria, OH (US); John J. Mayer, Westlake, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/266,407

(22) Filed: Oct. 8, 2002

(51) Int. Cl. F16D 7/02

(52) U.S. Cl. 464/30

(57) ABSTRACT

A variety of drive release assemblies are disclosed which are particularly well suited for use in conjunction with vehicular air compressors used to drive auxiliary components. The drive release assemblies utilize torque resisting surfaces to engage drive components, but which also serve to disengage the components upon application of excessive torque. Use of the drive release assemblies avoids damage that may otherwise occur to an engine or drive assembly upon torque overload.

### FIELD OF THE INVENTION

The present invention relates to a unique drive release assembly particularly suited for auxiliary power devices such as air brake compressors. The present invention provides several assemblies for disengaging an output shaft from a rotary power source upon application of an excessive degree of torque.

### BACKGROUND OF THE INVENTION

A wide variety of torque limiting or torque release devices are known in the prior art. Such devices are often used with engines and power delivery assemblies to prevent damage prior to application of excessive torque to the power delivery assembly and engine. If such torque is applied to a power assembly, resulting damage may occur to one or more devices being driven by the engine, to the engine, or to both engine and device(s) being driven.

Most torque limiting or torque release assemblies typically disengage a torque transfer device such as a clutch upon sensing an application of higher than desired torque loading conditions. However, most conventional torque limiting or torque release assemblies are relatively complicated and expensive to incorporate into a drive assembly.

It is therefore desirable to provide a simplified drive release mechanism that disengages a rotating power source from a corresponding drive component upon a threshold torque level being reached by the assembly. Furthermore, it is desirable to provide such a drive release mechanism that is relatively inexpensive to manufacture and readily incorporated between a power source and a device or component to be driven by the power source.

The present invention provides a new and improved apparatus and method which addresses the above-referenced problems.

### SUMMARY OF THE INVENTION

In one aspect of the present invention, a drive release mechanism exhibits a selectively determinable joint capacity. The mechanism includes a rotary powered drive shaft, a rotary drive member, and a fastener. In one embodiment, the rotary powered drive shaft has a first end and a second end. The drive shaft has an outwardly directed first torque resisting surface at least partially extending between the first end and the second end. The first end of the drive shaft defines a first aperture adapted to receive a fastener. The rotary drive member has an interior receiving cavity defined by an inwardly directed second torque resisting surface. The first end of the drive shaft is disposed in the interior cavity of the drive member such that at least a portion of the second torque resisting surface contacts at least a portion of the first torque resisting surface. The drive member further defines a second aperture. The fastener extends through the second aperture and into at least a portion of the first aperture. The drive member is releasably engaged to the drive shaft by sizing the first torque resisting surface of the drive shaft and the second torque resisting surface of the drive member to, exhibit a friction fit.

In another aspect of the present invention, a drive release assembly has a predetermined joint capacity. The assembly includes a drive gear and a drive shaft. In one embodiment, the drive gear has a first face and an oppositely directed second face. The drive gear defines a recessed region in at least one of the first face and the second face and further defines a centrally disposed first aperture extending between the first face and the second face. The drive gear further has a first torque resisting outer surface within the recessed region. A drive shaft has a first end and a second end. The first end of the shaft is disposed in the recessed region of the drive gear. The drive shaft further has a second torque resisting outer surface proximate the first end of the shaft and contacts at least a portion of the first torque resisting outer surface of the drive gear. The first end of the drive shaft defines a second aperture concentrically oriented and extending along the axis of rotation of the drive shaft. The recessed region of the drive gear frictionally contacts the first end of the drive shaft for creating a friction fit.

In yet another aspect of the present invention, a drive release mechanism has a selectively adjustable joint capacity. In one embodiment, the mechanism includes a powered drive shaft and a cylindrical coupler. The powered drive shaft has an end that defines an arcuate interior surface that forms a concentrically oriented cylindrical cavity extending within the shaft from the end along a portion of the length of the shaft. The cylindrical coupler has a first face, an oppositely directed second face, and an arcuate outer surface extending between the first face and the second face. The coupler defines a concentrically oriented aperture extending between the first face and the second face. The aperture is defined by an inwardly directed interior splined surface. The coupler is disposed in the cylindrical cavity. The interior span of the cylindrical cavity of the drive shaft and the outer diameter of the coupler are sized to result in a friction fit.

In yet another aspect of the present invention, a torque limiting device includes a gear and a means for driving the gear up to a predetermined torque via a frictional contact.

In yet another aspect of the present invention, a method of engaging a drive member to a drive shaft via a friction fit includes contacting a first torque resisting surface of the drive shaft with a second torque resisting surface of the drive member to exhibit the friction fit. In one embodiment, the first torque resisting surface is secured to the second torque resisting surface for creating a selectively determinable joint capacity between the drive shaft and the drive member.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to exemplify the embodiments of this invention.

FIG. 1 illustrates a preferred embodiment drive release mechanism in accordance with the present invention;

FIG. 2 illustrates another preferred embodiment drive release mechanism in accordance with the present invention;

FIG. 3 illustrates a representative air compressor for which the present invention is particularly well suited for incorporation therein;

FIG. 4 is a schematic cross-section of the air compressor shown in FIG. 3;

FIG. 5 is a cross-section of a crankshaft utilizing a preferred embodiment drive release mechanism in accordance with the present invention;

FIG. 5A is a partial end view of the crankshaft illustrated in FIG. 5, taken along line 5A-5A;

FIG. 6 illustrates a preferred embodiment slip release coupler for incorporation in a crankshaft or other drive member in accordance with the present invention;

FIG. 7 is a graph illustrating the relationship between various measurements of joint capacity and frictional fit in a preferred embodiment drive release mechanism in accordance with the present invention;

FIG. 8 is a graph illustrating various measurements of joint capacity and bolt torque in the preferred embodiment drive release mechanism in accordance with the present invention;

FIG. 9 is a graph illustrating the relationship between joint capacity and bolt torque in the preferred embodiment drive release mechanism in accordance with the present invention;

FIG. 10 is a graph illustrating the relationship between torque capacity and frictional fit in the preferred embodiment drive release mechanism in accordance with the present invention;

FIG. 11 is a graph illustrating calculated measurement error associated with the data of FIG. 10; and

FIG. 12 is a graph illustrating the relationship between torque capacity and frictional fit in the preferred embodiment drive release mechanism that is the subject of FIGS. 10 and 11.

### DETAILED DESCRIPTION OF ILLUSTRATED EMBODIMENT

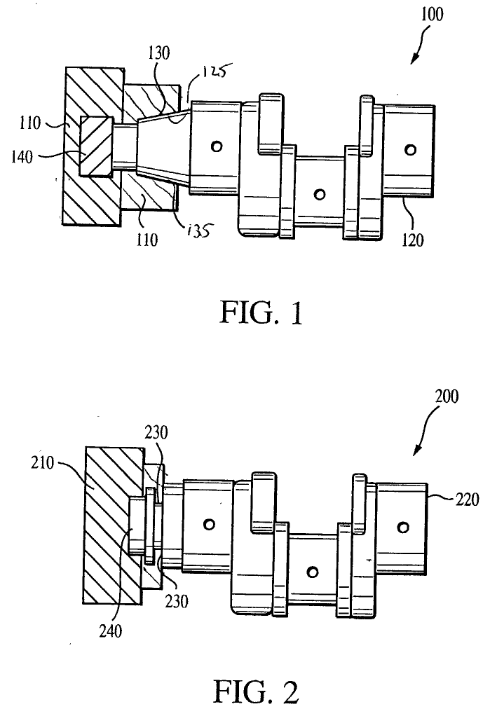

FIG. 1 illustrates a preferred embodiment drive release mechanism in accordance with the present invention. The preferred embodiment drive release mechanism 100 comprises a rotary drive gear 110 and a crankshaft 120. The drive gear 110 is operatively engaged with the crankshaft 120 such that rotation of the crankshaft 120 results in corresponding rotation of the drive gear 110. The drive gear 110 is secured to the crankshaft 120 by a fastener 140 (e.g., a bolt). As will be appreciated, in one embodiment, the fastener 140 is oriented axially and centered along the axis of rotation of the crankshaft 120 and the drive gear 110.

Furthermore, the gear 110 and crankshaft 120 each includes apertures through which the fastener 140 passes. In one embodiment, the fastener 140 is threaded to mate with the aperture in the crankshaft 120.

Preferably, the drive gear 110 defines a recessed region, cavity, or depression along one of its faces for receiving and engaging the crankshaft 120. The interface between the inner surface 125 of the recessed region of the drive gear and the outer surface 135 of the crankshaft is generally referred to herein as torque resisting surfaces 130. Specifically, the torque resisting surfaces 130 extend along the interface between the drive gear 110 and the crankshaft 120. It is these surfaces that transfer torque from one member to the other. Transfer of torque occurs as a result of friction between the surfaces 130. That is, relative movement between the inner surface 125 of the recessed region of the drive gear 110 and the outer surface 135 of the crankshaft 120 is precluded due to a relatively high degree of friction between the surfaces. The degree of friction between the surfaces is affected by the degree of tightness of the bolt 140.

Specifically, the present invention recognizes a correlation between the tightness of the bolt 140, expressed and referred to herein as, for example, bolt torque (e.g., measured in foot-pounds-force) and the amount of torque that may be transferred from the crankshaft to the drive gear, expressed and referred to herein as, for example, joint capacity (e.g., measured in foot-pounds-force). As the bolt torque is increased, the joint capacity increases. Restated, the amount of torque that the preferred embodiment drive release mechanism transfers from crankshaft to drive gear at the torque resisting surfaces 130 increases as the bolt torque increases, all other factors being held constant. This relationship is explained in greater detail herein.

FIG. 2 illustrates another preferred embodiment drive release mechanism in accordance with the present invention. The release mechanism 200 comprises a drive gear 210, a crankshaft 220, and a bolt 240 securing the drive gear 210 to the crankshaft 220. The interface between the drive gear 210 and the crankshaft 220 is generally referred to herein as torque resisting surfaces 230. It is these surfaces 230 that couple the drive gear 210 and crankshaft 220 together. As will be appreciated, the tightness of the bolt 240 affects the degree of friction between the components 210 and 220. Again, this relationship is explained in greater detail herein.

The preferred embodiment drive release mechanisms illustrated in FIGS. 1 and 2 differ from each other in the configuration of the torque resisting surfaces 130 and 230. The configuration of the torque resisting surfaces 130 is a tapered configuration as characterized by the conical interface between the drive gear 110 and the crankshaft 120. In contrast, the torque resisting surfaces 230 have a flat configuration as characterized by the cylindrical interface between the drive gear 210 and the crankshaft 220.

Each configuration has particular characteristics and advantages over the other. The flat face configuration, i.e., that illustrated in FIG. 2 for release mechanism 200, is generally preferred over the tapered configuration, i.e., that illustrated in FIG. 1 for release mechanism 100, for considerations of the degree of undesirable gear cantilever, manufacturing expense, and torque capacity variation. The tapered configuration is generally preferred over the flat face configuration for considerations of overall serviceability and of the ratio of bolt torque to joint capacity, because the tapered face configuration is less sensitive than the flat face configuration.

In the assemblies depicted in FIGS. 1 and 2, the drive components, i.e. the drive gear and the crankshaft, are generally initially pressed together (e.g., using a press force of 2000 pounds) and held together due to a frictional (e.g., interference) fit. Typically, such frictional fits range from about 0.001 mm to about 0.050 mm, and more preferably from about 0.005 mm to about 0.020 mm. At this preferred level of frictional fit, the joint capacity of the assembly ranges from about 45 foot-pounds to about 60 foot-pounds. That is, at a joint capacity of 50 foot-pounds, for example, the drive components remain engaged to one another. With this example, however, upon application of torque to the drive components exceeding 50 foot-pounds, the components will disengage from each other. Specifically, application of excessive torque will cause the torque resisting surfaces to slip or move past one another. As noted, significant increases in joint capacity are obtained upon tightening one or more threaded fasteners that secure the drive components together. For instance, using the preferred frictional fit noted above, tightening a threaded bolt such as bolt 140 or 240, to a torque level of from about 100 foot-pounds to about 300 foot-pounds, leads to an increase in joint capacity of from about 175 foot-pounds to about 425 foot-pounds.

In addition, the present invention includes drive release assemblies that utilize at least two components that are engaged to one another not by a bolt or fastener, such as previously described assemblies 100 and 200, but instead solely by a frictional fit. Specifically, in accordance with the present invention, a torque release surface may also be defined between two components that are held together by a friction (e.g., interference) fit. In this aspect of the present invention, the correlation between the degree of friction (e.g., interference) between the components and the joint capacity has been identified. Generally, as the degree of friction (interference) fit between components increases, the joint capacity increases. This is explained in greater detail herein.

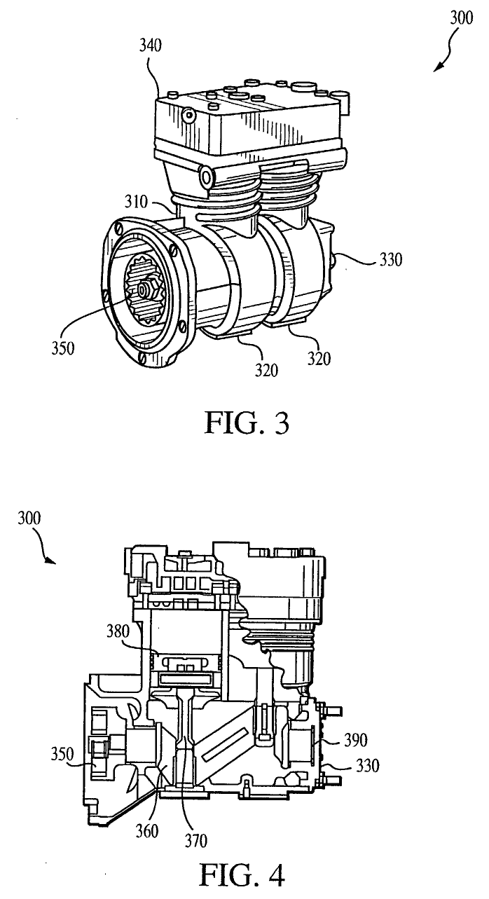

FIGS. 3 and 4 illustrate a representative vehicle air compressor which is particularly well suited for application of the present invention. Generally, these types of compressors are used for vehicle air brake systems, for example, on trucks. Typically, the compressors are driven by the vehicle engine and function continuously while the engine is in operation. FIGS. 3 and 4 illustrate that the air compressor 300 comprises a crankcase 310, a crankcase bottom cover 320, and a rear end cover 330. The air compressor 300 further includes a cylinder head 340, a compressor drive gear 350, a crankshaft 360, a connecting rod 370, one or more pistons 380, and a coupler 390.

Such air brake compressors are often additionally used to drive auxiliary power devices. These power devices are driven from the rear of the compressor, such as at the rear end cover 330, usually via a spline formed in the rear end of the crankshaft. Designing and forming splines into the ends of crankshafts is difficult and costly. The difficulty and expense stems from the nature of the blind hole or cavity defined along an end of the shaft, into which splines are machined. An alternative configuration in which a splined component is fitted into the blind hole would avoid significant manufacturing difficulties.

In accordance with the present invention, a drive release mechanism is utilized at the rear end of the crankshaft adjacent to the spline coupler. Without such a drive release mechanism, if one or more auxiliary devices driven from the compressor 300 experience excessive loading or a lock-up condition, damage to the compressor 300 may result. Incorporation of a drive release mechanism between the compressor 300 and the auxiliary devices protects the compressor.

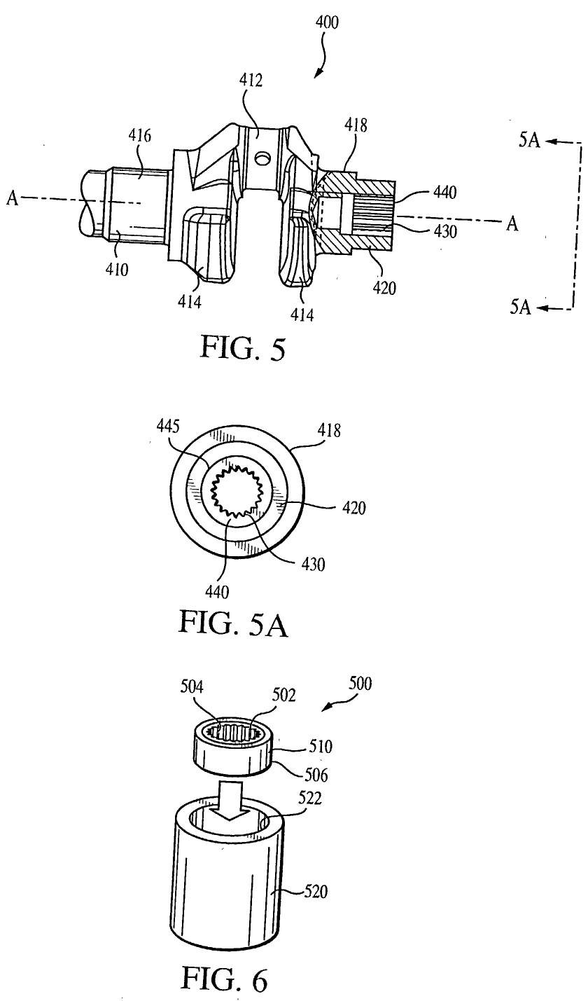

FIG. 5 illustrates a partial cross-section of a crankshaft 400 utilizing a preferred embodiment drive release mechanism in accordance with the present invention is illustrated. FIG. 5A illustrates in greater detail the portion of the crankshaft 400 depicted in FIG. 5 including a preferred embodiment drive release mechanism. This crankshaft 400 has a drive end 410 and an auxiliary output end 420. Defined within the auxiliary output shaft end 420, are a plurality of splines 430. The crankshaft 400 also includes one or more crank portions 412 that are offset from the axis of rotation of the crankshaft 400, illustrated in FIG. 5 as “A.” As will be appreciated, each of the crank portions are for engagement with a connecting rod and piston (not shown). The crankshaft 400 further includes a counterweight 414 for each crank portion 412 and crank journals 416 and 418. The crank journals 416 and 418 are rotatably supported by bearing portions of a cylinder block (not shown).

In accordance with the present invention, the crankshaft 400 has a drive release mechanism disposed along the output shaft end 420. This is illustrated in greater detail in FIG. 5A. Specifically, this preferred version of the drive release mechanism is embodied in the output shaft end 420, and comprises a slip release coupler 440 and the opposing surfaces that define the interface between the shaft end 420 and coupler 440, referred to herein as torque resisting surfaces 445. In this preferred embodiment of the present invention, the slip release coupler 440 defines a plurality of splines 430. The splines extend longitudinally and parallel to the axis of rotation A of the crankshaft 400. As will be appreciated, the splines 430 facilitate engagement with an auxiliary device to be driven from the end 420 of the crankshaft 400. The slip release coupler 440 fits within a cavity defined along the end 420 of the crankshaft. As will be understood, the torque resisting surfaces 445 extending along the outer surface of the slip release coupler 440 and the interior surface defining the cavity at the end 420 of the crankshaft 400 are generally circumferential.

The slip release coupler 440 is retained within the cavity defined along the shaft end 420 by a friction (e.g., interference) fit. Typically, the coupler 440 is pressed into the cavity.

Upon engagement of an auxiliary device to the splined coupler 440, rotation of the crankshaft 400 causes rotation of the auxiliary device. If an excessive torque condition occurs, such as between the shaft end 420 and the auxiliary device, the coupler 440 will slip by movement between the torque resisting surfaces 445 or otherwise disengage from the shaft end 420. This avoids damage to the crankshaft 400, connecting components, and the auxiliary device.

FIG. 6 illustrates another preferred embodiment slip release coupler 500 in accordance with the present invention. A preferred embodiment coupler assembly 500 includes a spline drive coupler 510, and a retaining shaft 520. Defined along the interior region of the spline drive coupler 510 are a plurality of splines 502. These splines 502 are defined along the interior circumferential surface or inner splined surface 504. The outer circumferential surface of the spline drive coupler 510 is defined as an outer torque resisting surface 506. Defined along one end of the retaining shaft 520 is an inner torque resisting surface 522. This is a circumferential inner surface that defines a cavity for receiving the coupler 510. Together, the outer torque resisting surface 506 of the coupler 510 and the inner torque resisting surface 522 define a circumferential interface. It is this interface that serves as the torque resisting surface to release the shaft 520 from the coupler 510 upon application of an excessive level of torque.

As previously described with regard to FIGS. 5 and 5A, the coupler 510 is engaged and retained within the retaining shaft 520 by a friction (e.g., interference) fit. The degree of friction (e.g., interference) between these components governs the degree of torque that is transmitted between the two, and specifically from the retaining shaft 520 to the coupler 510.

Depending upon the configuration of the components, materials, and application requirements, a wide range of friction (e.g., interference) fits may be utilized in the present invention. Generally, for most drive train systems, a friction (e.g., interference) fit of from about 0.001 mm to about 0.100 mm may be utilized. Preferably, such friction (e.g., interference) fit is from about 0.005 mm to about 0.060 mm. Most preferably, such friction (e.g., interference) fit is from about 0.005 mm to about 0.020 mm.

The following is a description of a series of tests undertaken to better characterize the present invention.

Testing

In a first set of trials, a collection of ten (10) sets of drive gears, crankshafts, and bolts for securing a gear to a crankshaft were obtained. Each of the gears and crankshaft sets defined an interface of torque resisting surfaces of the flat face configuration as described herein and depicted in FIG. 2.

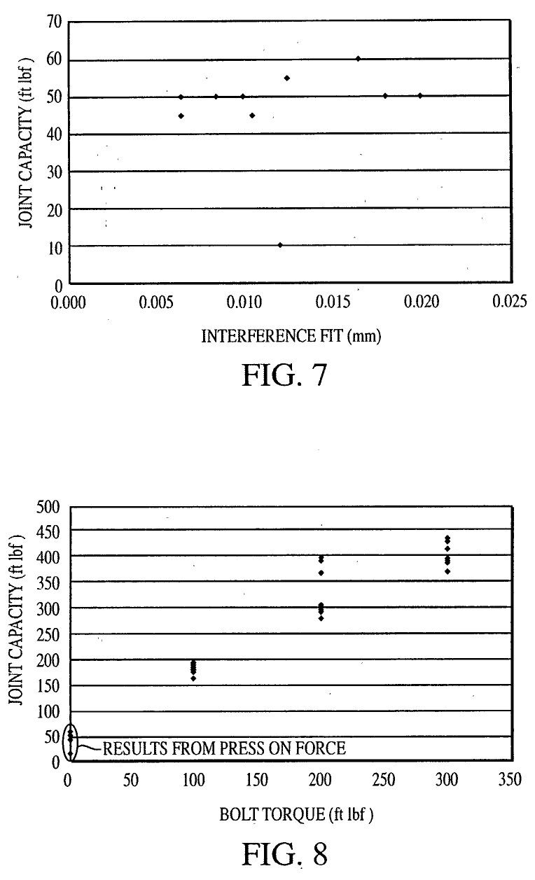

The surface finishes of the torque resisting surfaces for each of the sets varied. As a result, the friction (e.g., interference) fit between a gear and corresponding crankshaft varied from slightly more than 0.005 mm to about 0.020 mm. For each of these sets, the gear was pressed onto a crankshaft using 2000 pounds of force. The joint capacity (or torque capacity) was then measured in foot-pounds of force. FIG. 7 illustrates the relationship between the joint capacity and the friction (e.g., interference) fit. It can be seen that, generally, as the degree of interference or friction increased between the gear and crankshaft (along the torque resisting surfaces), the joint capacity increased.

After this initial set of measurements, bolts were then used to further secure each of the gears to a corresponding crankshaft. Joint capacity measurements were then made after tightening bolts to bolt torques of 100, 200, and 300 foot-pounds of force. These data points are illustrated in FIG. 8. It can be seen that significant increases in joint capacity can be obtained by moderate increases in bolt torque.

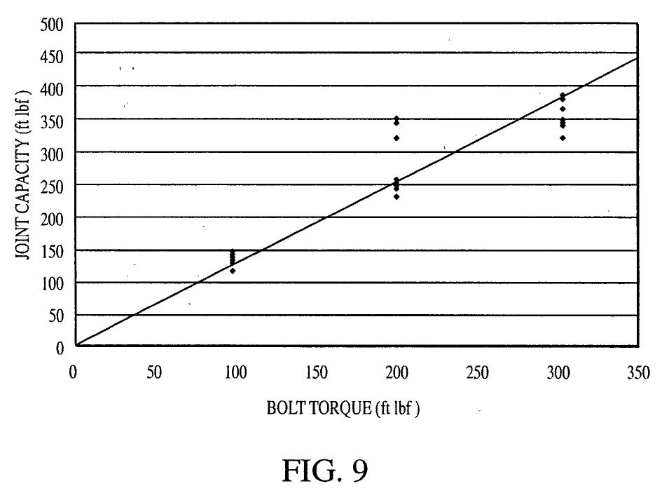

FIG. 9 illustrates the linear relationship between joint capacity and bolt torque based upon and fitted to the data collected and plotted in FIG. 8, without the joint capacity generated with the pressing of the gear onto the crankshaft.

In a second set of trials, the effect of surface finish and, thus, of the degree of friction (e.g., interference) upon joint capacity was investigated. In this trial, twenty (20) sets of spline couplers, similar to coupler 510 illustrated in FIG. 6, and spline holders, similar to holder 520 in FIG. 6, were obtained. The spline couplings were modified Sauer Sundstrand Part No. 1700138 formed from 8620 steel. The spline holders were formed from 4140 steel, had an outer diameter of 50 mm, and a length of about 25 mm. Each spline holder contained an aperture sized to receive a spline coupler.

As will be appreciated, the dimensions and surface finishes for each of the spline coupler and spline holder were important. The spline couplers were formed with outer diameters of 29.32±0.013 mm and had a surface finish less than 32 Ra. As will be understood, “Ra” refers to the roughness average and is a standard measure of surface roughness defined by ANSI/ASME B46.1-1985. The spline holders were formed with inner diameters sized to receive a corresponding spline coupler of 29.27±0.013 mm and had a surface finish less than 80 Ra.

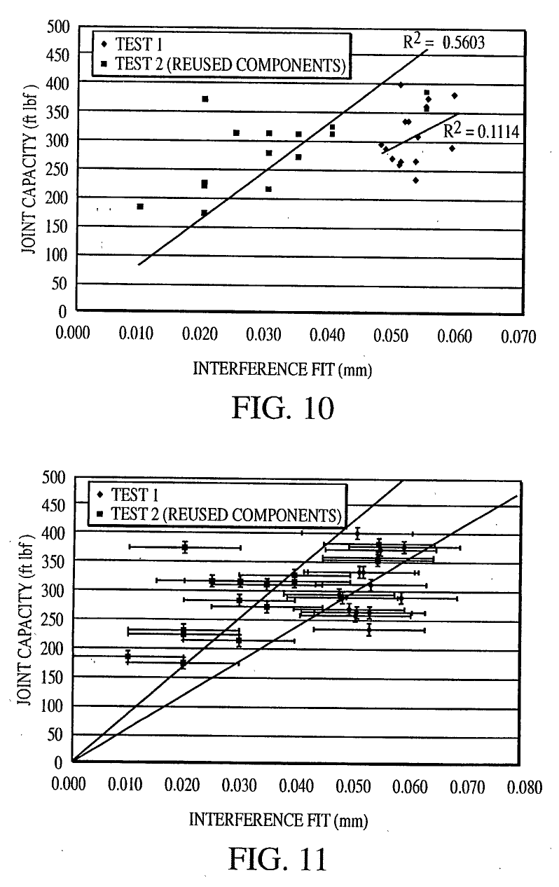

The various sets of spline couplers and spline holders were then assembled. The resulting assemblies had friction (e.g., interference) fits ranging from 0.048 mm to 0.060 mm. The minimum torque necessary to cause rotation of the spline coupler relative to the spline holder was then measured, in foot-pounds of force. The range of joint capacity measurements ranged from about 235 foot-pounds to about 400 foot-pounds. An approximate correlation was identified between a friction (e.g., interference) fit of from about 0.050 mm to about 0.060 mm resulting in a joint capacity of from about 235 foot-pounds to about 400 foot-pounds. The higher joint capacities were obtained by the assemblies having relatively large friction (e.g., interference) fits. A linear correlation was then fitted to the data, all of which are shown in FIG. 10 under the designation “Test 1.” The R2 value for that linear relation was 0.1114.

In another aspect of this trial, the previously described twenty sets of spline couplers and holders were disassembled. Accordingly, they had improved surface finishes from the first press-in operation. The parts were re-assembled and exhibited a greater range of friction (e.g., interference) fits, i.e. 0.010 mm to 0.060 mm. Corresponding joint capacity or torque values were then measured. The lowest torque value of 175 foot-pounds resulted at a friction (e.g., interference) fit of 0.020 mm. The maximum torque value of 375 foot-pounds resulted at a similar friction (e.g., interference) fit of 0.020 mm. A fitted linear curve for the data resulted in an R2 value of 0.56. This is illustrated in FIG. 10 with the designation “Test 2.”

In order to ensure a robust design for spline capacity, gauge readings were completed to study the error associated with the measurement gauges in the lab. Typically, external diameter measuring tools such as micrometers have an accuracy of only ±0.01 (micrometer and telescoping gauge). As illustrated in FIG. 11, when the square root of the sum of the squares for the tolerances is determined (±0.011) most of the data points could lie on the predicted curves. The tolerance in readings from a torque wrench, which indicates the torque capacity of the joint, has also been incorporated in the data of FIG. 11.

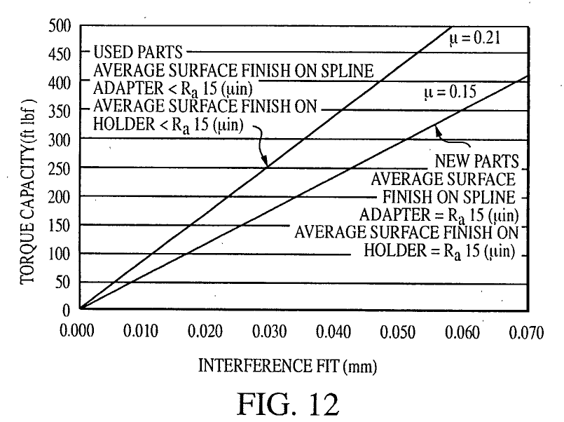

Using the data and information illustrated in FIGS. 10 and 11, two overall torque capacity versus friction (e.g., interference) fit curves are set forth in FIG. 12. As noted, one curve is for new parts, and the other is for used parts.

It will be appreciated that the present invention drive release mechanisms may be incorporated into a wide array of drive trains, drive assemblies, and power systems. Furthermore, it is contemplated that the present invention drive release mechanisms may be used in conjunction with numerous engine types and displacements. Moreover, the present invention drive release mechanism may be in other forms than the specific preferred embodiment assemblies described herein.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

I/We claim:

1. A drive release mechanism exhibiting a selectively determinable joint capacity, said mechanism comprising:
a rotary powered drive shaft having a first end and a second end, the drive shaft having an outwardly directed first torque resisting surface at least partially extending between the first end and the second end, the first end of the drive shaft defining a first aperture adapted to receive a fastener;
a rotary drive member having an interior receiving cavity defined by an inwardly directed second torque resisting surface, the first end of the drive shaft being disposed in the interior cavity of the drive member such that at least a portion of the second torque resisting surface contacts at least a portion of the first torque resisting surface, the drive member further defining a second aperture; and
a fastener extending through the second aperture and into at least a portion of the first aperture;
wherein the drive member is releasably engaged to the drive shaft by sizing the first torque resisting surface of the drive shaft and the second torque resisting surface of the drive member to exhibit a friction fit.

2. The drive release mechanism of claim 1 wherein:
the fastener is threaded; and
the first aperture is threaded for receiving the threaded fastener.

3. The drive release mechanism of claim 1 wherein said fastener is a threaded bolt.

4. The drive release mechanism of claim 1 wherein said friction fit ranges from about 0.001 mm to about 0.100 mm.

5. The drive release mechanism of claim 1 wherein said friction fit ranges from about 0.005 mm to about 0.060 mm.

6. The drive release mechanism of claim 1 wherein said friction fit ranges from about 0.005 mm to about 0.020 mm.

7. The drive release mechanism of claim 1 wherein said friction fit ranges from about 0.050 mm to about 0.060 mm and said drive release mechanism exhibits a joint capacity of from about 235 foot-pounds to about 400 foot-pounds.

8. The drive release mechanism of claim 1 wherein said mechanism exhibits a flat face configuration.

9. The drive release mechanism of claim 1 wherein said mechanism exhibits a tapered configuration.

10. The drive release mechanism of claim 1 wherein drive member and said first end of said drive shaft rotate about a common axis of rotation and are sized to exhibit a friction fit of from about 0.005 mm to about 0.020 mm.

11. The drive release mechanism of claim 10 wherein said drive member and said first end of said drive shaft are pressed together using 2000 pounds of force, to thereby cause the joint capacity of said mechanism to range from about 45 foot-pounds to about 60 foot-pounds.

12. The drive release mechanism of claim 11 wherein said fastener is a threaded bolt and is tightened to a torque level of from about 100 foot-pounds to about 300 foot-pounds to thereby cause the joint capacity of said mechanism to range from about 175 foot-pounds to about 425 foot-pounds.

13. The drive release mechanism of claim 1 wherein the friction fit is an interference fit.

14. A drive release assembly having a predetermined joint capacity, said mechanism comprising:
a drive gear having a first face and an oppositely directed second face, said drive gear defining a recessed region in at least one of said first face and said second face, and further defining a centrally disposed first aperture extending between said first face and said second face, said drive gear further having a first torque resisting outer surface within said recessed region;
a drive shaft having a first end and a second end, said first end of said shaft disposed in said recessed region of said drive gear, said drive shaft further having a second torque resisting outer surface proximate said first end of said shaft and contacting at least a portion of said first torque resisting outer surface of said drive gear, said first end of said drive shaft defining a second aperture concentrically oriented and extending along the axis of rotation of said drive shaft; and
wherein said recessed region of said drive gear frictionally contacts said first end of said drive shaft for creating a friction fit.

15. The drive release assembly of claim 14 further including:
a fastener extending through said second aperture and further disposed in said first aperture.

16. The drive release assembly of claim 15 wherein:
the second aperture is threaded; and
the fastener is threaded to mate with the second aperture.

17. The drive release assembly of claim 14 wherein the friction fit creates a joint capacity from/about 175 foot-pounds to about 425 foot-pounds between the drive gear and the drive shaft.

18. The drive release assembly of claim 14 wherein said assembly exhibits a tapered configuration between said drive gear and said drive shaft.

19. The drive release assembly of claim 14 wherein said assembly exhibits a flat configuration between said drive gear and said drive shaft.

20. A drive release mechanism having a selectively adjustable joint capacity, said mechanism comprising:
a powered drive shaft having an end that defines an arcuate interior surface that forms a concentrically oriented cylindrical cavity extending within said shaft from said end along a portion of the length of said shaft; and
a cylindrical coupler having a first face, an oppositely directed second face, and an arcuate outer surface extending between said first face and said second face, said coupler defining a concentrically oriented aperture extending between said first face and said second face, said aperture defined by an inwardly directed interior splined surface, said coupler disposed in said cylindrical cavity;
wherein the interior span of said cylindrical cavity of said drive shaft and the outer diameter of said coupler are sized to result in a friction fit.

21. The drive release mechanism of claim 20 wherein the friction fit is from about 0.001 mm to about 0.100 mm.

22. The drive release mechanism of claim 20 wherein the friction fit ranges from about 0.050 mm to about 0.060 mm to thereby produce a joint capacity of from about 235 foot-pounds to about 400 foot-pounds.

23. The drive release mechanism of claim 20 wherein the friction fit ranges from about 0.005 mm to about 0.020 mm.

24. The drive release mechanism of claim 20 wherein said drive shaft and said coupler are formed from steel and said arcuate outer surface of said coupler exhibits a surface roughness of less than 32 Ra.

25. The drive release mechanism of claim 20 wherein said drive shaft and said coupler are formed from steel and said arcuate interior surface exhibits a surface roughness of less than 80 Ra.

26. A torque limiting device, comprising:
a gear; and
means for driving the gear up to a predetermined torque via a frictional contact.

27. The torque limiting device as set forth in claim 26, wherein the means for driving includes:
a recessed region in the gear; and
a shaft frictionally contacting the gear in the recessed region.

28. The torque limiting device as set forth in claim 27, further including:
means for fastening the shaft in the recessed region.

29. The torque limiting device as set forth in claim 28, wherein the means for fastening includes a bolt.

30. The torque limiting device as set forth in claim 28, wherein:
the means for fastening is threaded;
the means for driving is threaded to mate with the threaded fastening means.

31. The torque limiting device as set forth in claim 26, further including:
a spline in the recessed region, the shaft frictionally contacting the spline.

32. A method of engaging a drive member to a drive shaft via a friction fit, the method comprising:
contacting a first torque resisting surface of the drive shaft with a second torque resisting surface of the drive member to exhibit the friction fit; and
securing the first torque resisting surface to the second torque resisting surface for creating a selectively determinable joint capacity between the drive shaft and the drive member.

33. The method of engaging a drive member to a drive shaft of claim 32, wherein the securing includes:
passing a fastener through an aperture of the drive member and into an aperture of the drive shaft.

34. The method of engaging a drive member to a drive shaft of claim 33, wherein the passing includes:
engaging a thread of the fastener with respective threads of the drive member and the drive shaft to selectively determine the joint capacity.

35. The method of engaging a drive member to a drive shaft of claim 32, wherein the contacting includes:
inserting a coupler of the drive member into the drive shaft, the first torque resisting surface of the drive shaft contacting the second torque resisting surface of the coupler.
